(19) United States
(12) Patent Application Publication
(10) Pub. No.: US 2006/0272915 A1
(43) Pub. Date: Dec. 7, 2006

(54) Actuator, particularly for a friction clutch with dispalcement by magnetorheological fluid

(75) Inventor: Theodor Gassmann, Siegburg (DE)

Correspondence Address: ARTZ & ARTZ, P.C., 28333 TELEGRAPH RD., SUITE 250, SOUTHFIELD, MI, 48034, US

(73) Assignee: GKN DRIVELINE INTERNATIONAL GMBH, Lohmar (DE)

(21) Appl. No.: 10/544,314

(22) PCT Filed: Feb. 2, 2004
(86) PCT No.: PCT/EP04/00914

§ 371 Date: Aug. 9, 2006

(30) Foreign Application Priority Data
Feb. 3, 2003 (DE) 103 04 140.0

(51) Int. Cl. F16D 27/00

(52) U.S. Cl. 192/21.5

(57) ABSTRACT

A friction coupling for coupling and uncoupling two parts which are rotatable relative to one another, having a coupling carrier (11) which carries outer plates (31) of a plate package (29) and a coupling hub (12) which carries inner plates (32) of the plate package (29), as well as an axially displaceable piston (25) which is able to load, or remove the load from, the plate package (29) which is axially supported on the coupling carrier (11) or on the coupling hub (12). The piston (25), on one side, delimits an annular-cylindrical chamber (26) which rotates with the coupling carrier (11), and in which there rotates a rotor disc 27 which is connected to the coupling hub (12) and which comprises at least one displacer blade (29). The annular-cylindrical chamber (26) is filled with a magneto-rheological fluid and sealed towards the outside. The piston (25) includes a ferro-magnetic material, and opposite the piston (25), there is arranged a controllable magnetising coil (24) which is able to generate a magnetic flow over the chamber (26) and the piston (25).

The invention relates to an actuator for axial setting, comprising two parts which are rotatable relative to one another. Furthermore, the invention relates to a friction coupling for coupling and uncoupling two parts which are rotatable relative to one another. Such a friction coupling comprises a coupling carrier which carries outer plates of a plate package and which can be connected to the first one of the parts; a coupling hub which carries inner plates of a plate package and which can be connected to the second one of the parts, as well as an axially displaceable piston which is able to load, or remove the load from, the plate package supported on the coupling carrier or on the coupling hub in order to close or to open the friction coupling.

In motor vehicles driven by a plurality of axles such couplings are frequently arranged in the driveline leading to an optionally driven driving axle. Because the control strategies for driving vehicles driven by a plurality of axles become more and more complicated, very different solutions have been proposed for actuating such friction couplings and thus for setting said piston. In many cases, setting is effected via pairs of ramp discs driven by an electric motor, wherein two fixed ramp disc comprise ball grooves which extend in opposite directions, whose depth is variable and in which there run balls which support the ramp discs relative to one another. One disc is axially supported and the other one is axially displaceable. If one disc is rotated relative to the other one, the one disc can be displaced relative to the axially supported other disc and thus load the piston. The design examples of which are found in the Applicant's publication DE 38 15 225 C2 is relatively complicated.

Instead of rotating the one of the ramp discs by an electric motor in devices of said type, there have also been proposed retaining mechanisms or braking mechanisms for the one of the discs of two ramp discs rotating together, which mechanisms also effect a relative rotation of the two discs and thus also axially displace the other one of the discs and load a piston for actuating the coupling plates. It is already known to cause the rotatable one of the two ramp discs of a viscous coupling of an annular-cylindrical design filled with a magneto-rheological fluid to be braked. By changing the magnetic flow by means of the fluid, it is possible to influence the viscosity of the fluid and thus the extent of the effect of a speed differential between the coupling carrier and the coupling hub on the setting of the friction coupling. Such a coupling is described in U.S. Pat. No. 5,915,513.

According to a different more simply designed coupling assembly it is proposed that in a friction coupling of said type, the piston delimits an annular cylindrical chamber which rotates with the one of the coupling parts, more particularly with the coupling carrier and in which there rotates a rotor disc rotating with the other one of the coupling parts, more particularly the coupling carrier, and having a plurality of displacer blades. The displacer blades assume the cross-section of the chamber. The chamber is almost completely filled with a highly viscous fluid. A rotational movement of the rotor disc in the chamber, as a result of the displacer blades in the fluid, generates a pressure build-up which is proportional to the kinematic viscosity of the fluid. Such a coupling is described in U.S. Pat. No. 5,056,640.

It is the object of the present invention to provide an actuator, more particularly for a friction coupling, as well as a friction coupling which features a simple design and which provides improved control possibilities. The objective is achieved in that a piston, on one side, delimits an annular-cylindrical chamber which rotates with the one of the parts, more particularly with the coupling carrier and in which there rotates a rotor disc which is connected to the other one of the parts, more particularly the coupling hub and which comprises at least one displacer blade, that the annular-cylindrical chamber is filled at least to a considerable extent, with a magneto-rheological fluid and is sealed towards the outside and that there is provided a controllable magnetising coil which is able to generate a magnetic flow through the chamber. The coupling described here permits a much wider range of control strategies. Whereas so far, the operation of closing the coupling in accordance with a fixed characteristic curve was dependent on the speed differential between the input end and the output end, and there was a need, for example, for providing a separate switching coupling for disconnecting the input end and the output end under certain driving conditions, the friction coupling in accordance with the present invention allows the respective control strategies to be achieved entirely via the control of the coupling. In the case of a non-magnetised magneto-rheological fluid, the viscosity can be so low that even if there exist considerable speed differentials, there is no pressure-build-up in the chamber to ensure that the coupling remains open and that no torque is transmitted which influences the driving condition. This means that, by setting the “non-magnetised” mode, the friction coupling is able to assume the function of a releasing coupling. However, if the magneto-rheological fluid is magnetised, it is possible, if required, optionally, by changing the viscosity, thus having a freely selectable pressure build-up in the chamber, for the coupling to be closed even at low speed differentials and to transmit torque effectively. In this way, it is possible, in the “magnetised” mode, to achieve locking effects of the friction coupling even with very low speed differentials between the input end and the output end, which locking effects could so far not be achieved by simple means.

According to a preferred embodiment it is proposed for the magnetising coil to be arranged in a fixed housing part. This simplifies the power supply which thus does not require any rubbing contacts. Furthermore, it is proposed that the piston consists of a ferromagnetic material and that the magnetising coil is arranged opposite the piston on the other side of the annular-cylindrical chamber. In this way, the magnetic flow is guided over the piston.

In the preferred embodiment of a friction coupling described later, the coupling carrier is connected to the input shaft and the coupling hub to the output shaft, with the magnetising coil, more particularly, being arranged at the output end with reference to the plate package. The chamber is delimited opposite the piston, on the other side, by a cover inserted into the coupling carrier.

For compensating for the change in volume in the chamber due to thermal expansion in the magneto-rheological fluid and for compensating for the change in volume in the chamber due to the displacement of the piston, special measures have to be taken. According to a first proposal, the chamber, in addition to containing the magneto-rheological fluid, can contain a small percentage of gas volume whose compressibility compensates for the change in volume. According to a further proposal, the chamber can be filled completely with a magneto-rheological fluid while being connected to a compensating chamber whose volume is variable and which is also filled with a magneto-rheological fluid.

The at least one displacer blade takes the cross-section of the chamber if viewed in the circumferential direction half way from the periphery to the central axis substantially completely.

The configurations of the magnetising coil, the chamber and piston have to be adapted to one another in such a way that, upon excitation of the magnetising coil, there is generated as uniform a magnetic field in the chamber as possible, so that a uniform viscosity of the fluid can be set.

A preferred embodiment of the invention will be described below with reference to the drawings wherein

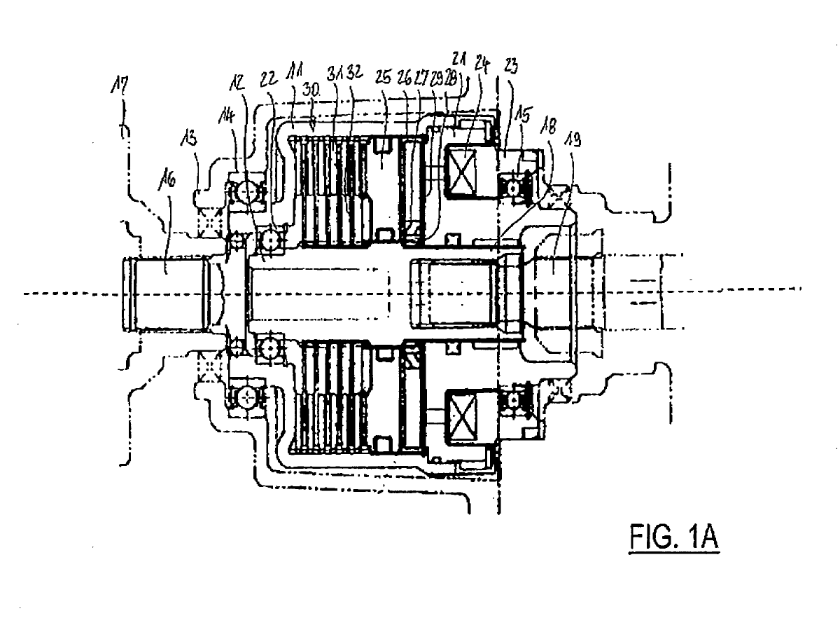

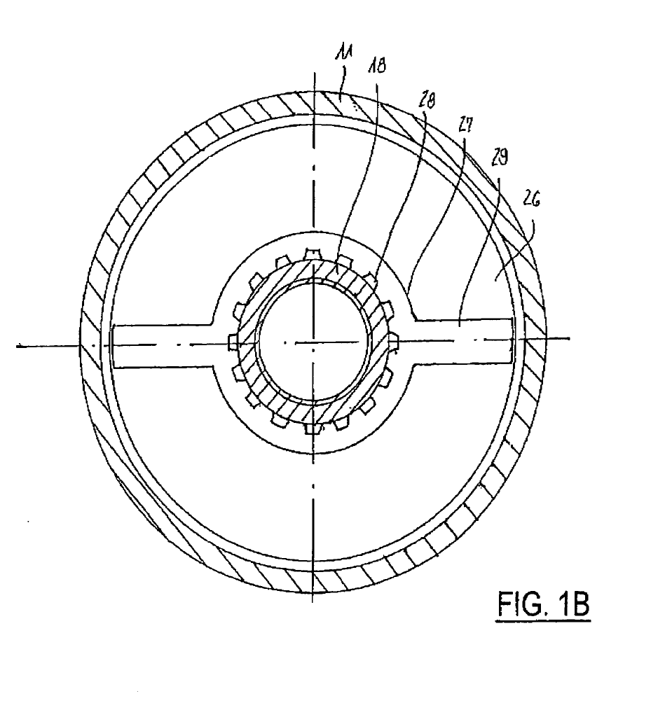

FIG. 1 shows an inventive coupling
a) in a longitudinal section
b) in a half-section through the rotor disc.

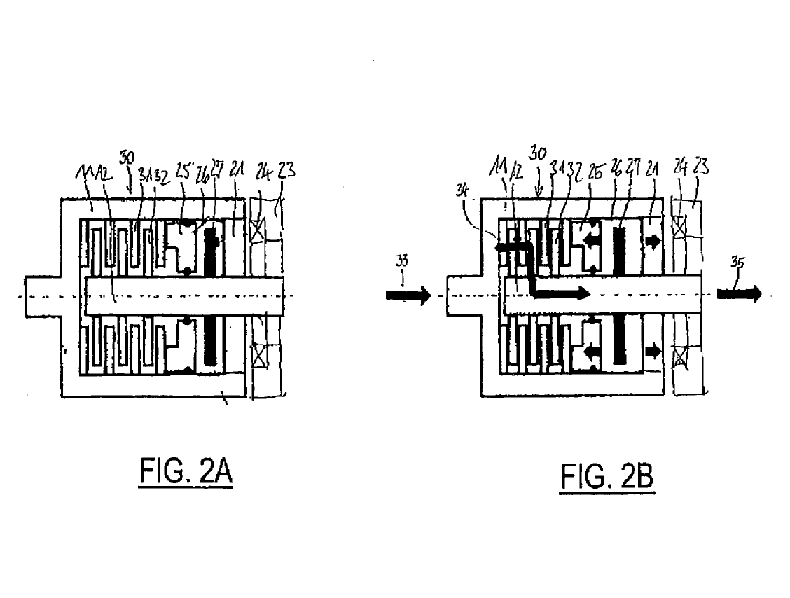

FIG. 2 shows a schematic diagram of the coupling according to FIG. 1
a) with the coupling in an open position
b) with the coupling in a closed position.

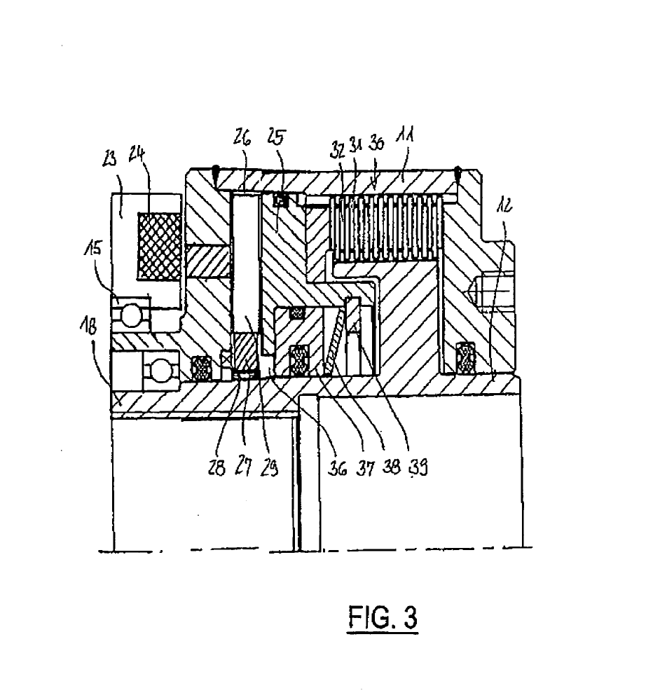

FIG. 3 shows an inventive coupling in a half-section in a second embodiment.

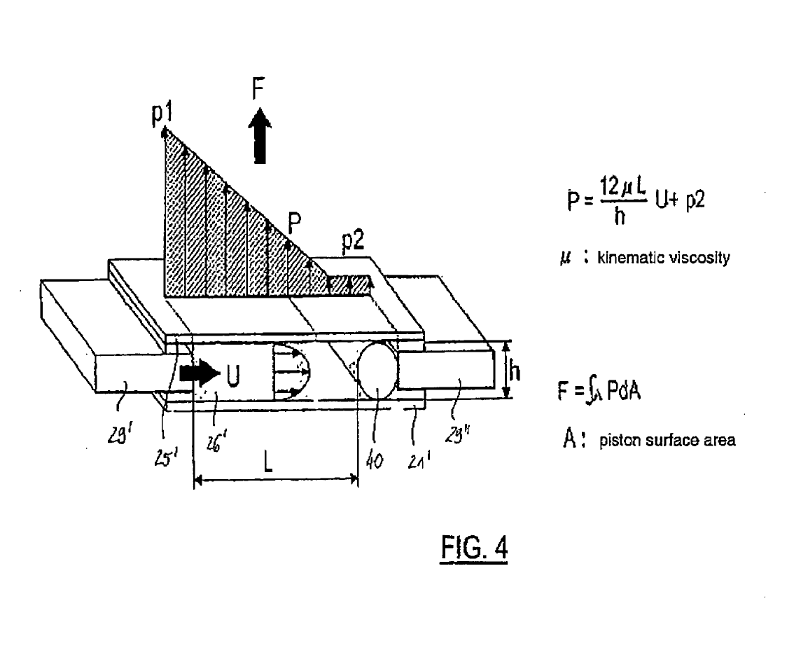

FIG. 4 shows a schematic diagram explaining the generation of pressure in the chamber.

FIG. 1a shows an inventive coupling whose input end comprises a coupling carrier 11 and whose output end comprises a coupling hub 12. The coupling carrier is rotatably supported in a fixed housing 13 by means of two ball bearings 14, 15. The coupling carrier 11 ends on the left in a shaft journal 16 on which there is positioned a driving flange 17. The coupling hub 12 comprises a sleeve 18 into which there is inserted an output shaft 19. Into the coupling carrier 11 there is inserted a cover 21 in a rotationally fast way; it is positioned on the sleeve 12 so as to be sealed. The cover 21 is supported directly via the ball bearing 15 in a housing insert 23 which carries an annular magnetising coil 24. Between the coupling carrier 11 and the coupling hub 12, at an axial distance from the cover 21, there is positioned a piston 25 which is sealed relative to the coupling carrier 11 and the coupling hub 12 and which is axially displaceable. The cover 21 and the piston 25 form an annular-cylindrical chamber 26 which is substantially entirely filled with a magneto-rheological fluid. The annular-cylindrical chamber 26 contains a rotor disc 27 with two radial displacer blades 29, which rotor disc 27 is connected via a shaft toothing 28 to the coupling hub 12 in a rotationally fast way. The piston 25 and the magneto-rheological fluid in the annular-cylindrical fluid can be magnetised by the magnetising coil 24. This results in a change in the viscosity of the magneto-rheological fluid. If there takes place a relative rotation between the rotor disc 27 and the housing 21, a pressure build-up occurs in the chamber 26, which leads to a displacement of the piston 25. When the annular-cylindrical chamber 26 is increased in size, the piston 25 is able to apply an axial load to the plate package 30 which is axially supported on the coupling carrier 11 and which consists of outer plates 31 connected to the coupling carrier 11 and inner plates 32 connected to the coupling hub 12. By applying a load to the plate package 30, the coupling hub 12 is coupled to the coupling carrier 11 and thus the output 19 is coupled to the shaft journal 16.

FIG. 1b, in a cross-section through the chamber 26 which, on the inside, is delimited by the sleeve 18 and, on the outside, by the coupling carrier 11, shows the rotor disc 27 with the shaft toothing 28 and two radial displacer blades 29,

FIG. 2 is a schematic diagram of the major functional parts of the coupling according to FIG. 1, and any parts identical to those shown in FIG. 1 have been given the same reference numbers. To that extent, reference is made to the previous description. Substantially, there are illustrated the carrier 11, the hub 12, the plate package 30 with outer plates 31 and inner plates 32, the piston 25, the annular-cylindrical chamber 26, the rotor disc 27, the cover 21, the housing insert 23 and the magnetising coil 24. In illustration a) the magnetising coil 24 is not excited, which means that the magneto-rheological fluid in the chamber 26 comprises a lower viscosity. With an assumed speed differential between the coupling carrier 11 constituting the input end and the coupling hub 12 constituting the output end, there does not take place a substantial pressure build-up in the annular-cylindrical chamber 26. The piston 25 applies no forces to the plate package 29. In illustration b) the magnetising coil 24 is excited. The viscosity of the magneto-rheological fluid in the chamber 26 is greatly increased. With an assumed speed differential between the coupling carrier 11 constituting the input end and the coupling hub 12 constituting the output end, the rotor disc 27 generates a pressure in the chamber 26, which pressure displaces the piston 25 against the plate package 29 which thus connects the coupling hub 12 to the coupling carrier 11. As indicated by arrows 33, 34, 35, there occurs a torque flow from the input end to the output end, i.e. from the coupling carrier 11 via the plate package 29 to the coupling hub 12.

In FIG. 3, the same details as shown in FIG. 1 have been given same reference numbers as in FIG. 1. To that extent, reference is made to the description of FIG. 1. However, FIG. 3 deviates from FIG. 1 in that, in the piston 25, there is provided a compensating reservoir 36 which is openly connected to the chamber 26 and, in the present case, is limited to its minimum volume. The compensating reservoir 36 is delimited by a compensating piston 37 which, via a plate spring 38 and a disc 39, is axially resiliently supported on the piston 25.

FIG. 4 illustrates the principle of generating pressure in the chamber, wherein the rotational movement of the displacer blades in the chamber is changed into a linear movement of two blade ends 29′, 29″ in the chamber 26′. The chamber is otherwise formed by a fixed housing 21′ and a displaceable piston 25′ which are each only shown in the form of portions. In front of the blade 29′, in the direction of movement as indicated, there builds up a pressure, whereas behind the blade 29″, in the direction of movement, the lowest pressure prevails, which results in a gas volume 40 collecting in this region. Above the piston 25′, there is shown the profile of the pressure in the direction of the chamber length L, with the highest pressure p1 prevailing directly in front of the displacer blade 29′ and wherein, in the gas volume 40, there prevails the lowest constant pressure p2 within the volume. The local pressure in the chamber is given as p=12 μL/h×U+p2, with L and h representing the dimensions of the chamber, U is the circumferential speed of the displacer blades 29′, 29″ and μ the kinematic viscosity of the magneto-rheological fluid; the latter can be varied. The piston force is given as F=∫_{A}PdA, with A representing the total piston surface of the piston 25′.

### LIST OF REFERENCE NUMBERS

11 coupling carrier
12 coupling hub
13 housing
14 ball bearing
15 ball bearing
16 shaft journal
17 flange
18 sleeve
19 driveshaft
20 ball bearing
21 cover
22 ball bearing
23 housing insert
24 magnetising coil
25 piston
26 chamber
27 rotor disc
28 shaft toothing
29 displacer blade
30 plate package
31 outer plates
32 inner plates
33 arrow
34 arrow
35 arrow
36 compensating reservoir
37 compensating piston
38 plate spring
39 disc
40 gas volume

1. An actuator for axial setting, comprising:
two parts which are rotatable relative to one another:
a piston which, at one end, delimits an annular-cylindrical chamber which rotates with one of the parts and in which there rotates a rotor disc which is connected to the other one of the parts and which comprises at least one displacer blade, wherein the annular-cylindrical chamber is filled at least partially with a magneto-rheological fluid and sealed towards the outside; and
a controllable magnetising coil adapted to generate a magnetic flow through the chamber.

2. An actuator according to claim 1, wherein the magnetising coil is arranged in a fixed housing part.

3. An actuator according to claim 1, wherein the piston comprises a ferro-magnetic material, and the magnetising coil is arranged opposite the piston on the other side of the annular-cylindrical chamber.

4. An actuator according to claim 1, wherein one of the parts is connected to an input shaft and the other one of the parts to an output shaft.

5. An actuator according to claim 1, wherein the chamber further contains a small percentage of a gas volume.

6. An actuator according to claim 1, wherein the chamber is completely filled with a magneto-rheological fluid and is connected to a compensating chamber which is also filled with a magneto-rheological fluid and whose volume is variable.

7. An actuator according to claim 1, wherein the at least one displacer blade of the rotor disc substantially fills the chamber in a half section.

8. An actuator according claim 1, wherein the magnetising coil, the chamber and the piston are designed in such a way that, upon excitation of the magnetising coil, the chamber is substantially uniformly affected by a magnetic field.

9. An actuator according to claim 1, wherein a cover inserted into the one of the parts delimits the chamber opposite the piston.

10. A friction coupling for coupling and uncoupling two parts which are rotatable relative to one another, comprising:
a coupling carrier which carries outer plates of a plate package and which can be connected to the first one of the parts;
a coupling hub which carries inner plates of the plate package and which can be connected to the second one of the parts; and
an axially displaceable piston which is able to load, or remove the load from, the plate package which is axially supported on the coupling carrier or on the coupling hub;
the piston, on one side, delimiting an annular-cylindrical chamber which rotates with the one of the coupling parts, and in which there rotates a rotor disc which is connected to the other one of the coupling parts, and which comprises at least one displacer blade,
wherein the annular-cylindrical chamber is filled at least partially with a magneto-rheological fluid and sealed towards the outside and wherein there is provided a controllable magnetising coil which is able to generate a magnetic flow through the chamber.

11. A friction coupling according to claim 10, wherein the magnetising coil is arranged in a fixed housing part.

12. A friction coupling according to claim 10, wherein the piston comprises a ferromagnetic material, and the magnetising coil is arranged opposite the piston on the other side of the annular-cylindrical chamber.

13. A friction coupling according to claim 10, wherein the coupling carrier is connected to the input shaft and the coupling hub to the output shaft.

14. A friction coupling according to claim 10, wherein the chamber further contains a small percentage of a gas volume.

15. A friction coupling according to claim 10, wherein the chamber is completely filled with a magneto-rheological fluid and is connected to a compensating chamber which is also filled with a magneto-rheological fluid and whose volume is variable.

16. A friction coupling according to claim 10, wherein the at least one displacer blade of the rotor disc substantially fills the chamber in a half section.

17. A friction coupling according to claim 10, wherein the magnetising coil, the chamber and the piston are designed in such a way that, upon excitation of the magnetising coil, the chamber is substantially uniformly affected by a magnetic field.

18. A friction coupling according to claim 10, wherein a cover inserted into the coupling carrier delimits the chamber opposite the piston.

19. A friction coupling according to claim 10, wherein the annular cylindrical chamber rotates with the coupling carrier, and the rotor disk is connected to the coupling hub.
